(19) United States
(12) Patent Application Publication
(10) Pub. No.: US 2011/0210015 A1
(43) Pub. Date: Sep. 1, 2011

(54) SOLID ELECTROLYTE SENSOR ELEMENT HAVING A COMBUSTION GAS-SENSITIVE ANODE

(76) Inventors: Detlef Heimann, Gerlingen (DE); Henrico Runge, Stuttgart (DE); Holger Reinshagen, Bamberg (DE); Lothar Diehl, Gerlingen (DE)

(21) Appl. No.: 12/521,180

(22) PCT Filed: Nov. 8, 2007
(86) PCT No.: PCT/EP07/62053

§ 371 Date: May 23, 2011

(30) Foreign Application Priority Data
Dec. 29, 2006 (DE) 10 2006 061 955.2

(51) Int. Cl. G01N 27/407

(52) U.S. Cl. 205/783.5; 204/424; 204/427; 204/408

(57) ABSTRACT

A sensor element is provided for determining at least one physical property of a gas mixture in at least one gas chamber, which includes at least one component to be identified, especially oxygen, and at least one oxidizable component, especially a combustion gas. The sensor element has at least one first electrode, at least one second electrode, and at least one solid electrolyte connecting the at least one first electrode and the at least one second electrode. The at least one second electrode has a lower catalytic activity, particularly a lower electrocatalytic activity with respect to the at least one oxidizable component than the at least one first electrode.

### FIELD OF THE INVENTION

The present invention relates to sensor elements that are based on electrolytic properties of certain solids, namely the capability of these solids of conducting certain ions.

### BACKGROUND INFORMATION

Such sensor elements are used particularly in motor vehicles for measuring air/fuel gas mixture compositions. In particular, sensor elements of this type are called “lambda probes”, and they play an important part in the reduction of pollutants in exhaust gases, both in Otto engines and in Diesel technology. In combustion technology, the so-called air ratio “lambda” (λ) generally denotes the ratio of an actually supplied air mass to the air mass required theoretically (i.e., stoichiometrically). The air ratio is measured, in this context, using one or more sensor elements mostly at one or more locations in the exhaust tract of an internal combustion engine. Correspondingly, “rich” gas mixtures (i.e., gas mixtures having an excess in fuel) have an air ratio λ<1, whereas “lean” gas mixtures (i.e., gas mixtures having a fuel deficiency) have an air ratio λ>1. Besides in motor vehicle technology, such and similar sensor elements are also used in other fields of technology (especially in combustion technology), such as in aviation technology or in the control of burners, for instance, in heating systems or power stations. Numerous different developments of the sensor elements are described, for instance, in “Sensoren im Kraftfahrzeug” [Sensors in the Motor Vehicle], June 2001, p. 112-117, or in T. Baunach et al.: “Sauberes Abgas Burch Keramiksensoren” [Clean Exhaust Gas Through Ceramic Sensors], Physik Journal 5 (2006) No. 5, p. 33-38.

One development is the so-called voltage-jump sensor, whose measuring principle is based on measuring an electrochemical potential difference between a reference electrode exposed to a reference gas and a measuring electrode exposed to the gas mixture to be measured. Reference electrode and measuring electrode are interconnected via the solid state electrolyte, zirconium dioxide (i.e., yttrium-stabilized zirconium dioxide) or similar ceramics generally being used as solid state electrolyte due to their oxygen ion-conducting properties. Theoretically, the potential difference between the electrodes, especially in the transition between a rich gas mixture and a lean gas mixture, exhibits a characteristic abrupt change, which can be utilized to measure and/or control the gas mixture composition. Various exemplary embodiments of such voltage jump sensors, which are also known as “Nernst cells,” are described in German Patent Application Nos. DE 10 2004 035 826 A1, DE 199 38 416 A1 and DE 10 2005 027 225 A1, for example.

Alternatively or in addition to voltage-jump sensors, so-called “pump cells” are also used, in which an electrical “pumping voltage” is applied to two electrodes connected via the solid electrolyte, the “pumping current” being measured by the pump cell. In contrast to the principle of the voltage-jump sensors, in the case of pump cells both electrodes are usually in contact with the gas mixture to be measured. In the process, one of the two electrodes is directly exposed to the gas mixture to be measured (usually via a permeable protective layer). As an alternative, this electrode also may be exposed to an air reference. However, the second of the two electrodes is usually designed so that the gas mixture is unable to reach this electrode directly, but must first penetrate a so-called “diffusion barrier,” in order to reach a cavity adjoining this second electrode. In most cases, a porous ceramic structure having selectively adjustable pore radii is used as diffusion barrier. If lean exhaust gas penetrates this diffusion barrier and enters the cavity, oxygen molecules are electrochemically reduced to oxygen ions at the second, negative electrode by the pumping voltage, are transported through the solid state electrolyte to the first positive electrode and are there released again as free oxygen. The sensor elements are mostly operated in so-called limit current operation, which means in an operation in which the pumping voltage is selected so that the oxygen entering through the diffusion barrier is pumped completely to the counterelectrode. In this operation, the pumping current is approximately proportional to the partial pressure of the oxygen in the exhaust-gas mixture, so that sensor elements of this type are also frequently referred to as proportional sensors. In contrast to voltage-jump sensors, pump cells are able to be used across a relatively wide range for the air ratio lambda, which is why pump cells are used in particular in so-called broadband sensors, in order to measure and/or regulate also in the case of gas mixture compositions beyond λ=1.

The abovementioned sensor principles of voltage-jump cells and pump cells may advantageously also be used in combination, in so-called “multicell units”. For instance, the sensor elements may include one or more cells operating according to the voltage-jump sensor principle, and one or more pump cells. One example of a so-called “double-cell unit” is described in European Patent No. EP 0 678 740 B1. Using a Nernst cell, the partial oxygen pressure of a pump cell is measured in the cavity described above, that borders on the second electrode, and the pumping voltage is corrected by a closed-loop control in such a way that the condition λ=1 constantly prevails in the cavity. Various modifications of this multi-cell design are known. For example, a design is described in European Patent No. EP1 324 027 A2 in which as a measuring electrode of the voltage-jump cell (i.e. as an electrode situated in the cavity) a mixed electrode is used having an admixture of Au, Ag, Cu or Pb. In the conventional platinum electrodes, jump-characteristics curve U_{Nernst}(λ), at λ=1 runs very steeply, whereas outside λ=1 practically no more change can be measured in the dependence on air ratio λ. The material selection for the measuring electrode described in European Patent No. EP1 324 027 A2, on the other hand, ensures a “flatter” course of characteristics curve U_{Nernst}(λ), so that, even away from λ=1, a signal variation can still be measured. In EP1 324 027 A2, moreover, the use of this electrode material as cathode material of a pump cell is also described, in order to avoid the decomposition of nitrogen oxides (NOₓ) at the pump cathode.

In practice, however, the usual sensor elements, particularly sensor elements according to pump cell operation, demonstrate various problems, be they single cell or multi-cell units. Thus, in a lean gas mixture at a sufficiently high air ratio, as a rule, a positive pumping current (lean pumping current) is measured, from which one is able to calculate backwards to determine the oxygen content of the gas mixture. In many cases, the pumping current is proportional to the oxygen concentration in the gas mixture, for example. In theory, at decreasing air ratio λ, the pumping current characteristics curve should tend to zero, and disappear in the rich range, that is, for λ<1, (i.e. Iₚ=0). Actually, one may observe, however, that a positive pumping current also occurs in a rich gas mixture, even if the applied pumping voltage (usually ca. 600 to 700 mV) is clearly below the decomposition voltage of water (ca. 1.23 V). Based on the non-uniqueness of the characteristics curve in practice, one is therefore generally not able to calculate backwards to obtain the air ratio from the characteristics curve by itself. Thus, one could particularly observe that in the slightly lean range (for instance, at ca. λ=1.3), at a decreasing air ratio λ, a rise in the pumping current may already be detected. This is noticeable particularly in the regulation of Diesel engines, in which typically regulation takes place using slightly lean mixtures, for example, specifically at the air ratio λ=1.3 mentioned, so as to achieve optimum reduction in exhaust gas emission. The conventional sensor elements thus have considerable shortcomings exactly in this area, that is so critical for Diesel technology, which makes accurate regulation more difficult, and with that also the fulfillment of modern exhaust gas norms.

### SUMMARY

An example embodiment of the present invention is based on the realization that the deviations of the pumping current characteristics curve in the range near λ=1 (that is, in the slightly lean range and in the rich range) may generally be traced to combustion gases (i.e., oxidizable components) contained in the gas mixture. Combustion gas processes of the following type particularly take place at the pump anode:

CO+0²⁻CO₂+2e⁻

H₂+0²⁻H₂0+2e⁻.

In the rich gas mixture, as well as in the slightly lean range, oxidizable components are present in the form of combustion gases H₂ and CO, in order to let the reactions run, that were described. The current flowing in the process can hardly be distinguished from a measuring technology point of view, which results in the rise again of the characteristics curve at an air ratio λ that is becoming smaller, and, with that, in the non-uniqueness of the characteristics curve. Thus, one idea of the present invention is to apply suitable methods for effectively preventing the reactions described at the pump anode, that run in rich gas and/or in a slightly lean range, or at least to minimize them.

A sensor element is therefore provided which is designed to analyze a gas mixture composition having at least one identifiable component (particularly oxygen) and at least one oxidizable component (particularly a combustion gas, such as H₂, hydrocarbons, carbon monoxide, etc.), and especially to measure their air ratios λ. The sensor element is able to be implemented within the scope of a one-cell unit and also within the scope of a multi-cell system. The sensor element includes at least one first electrode, at least one second electrode, and at least one solid electrolyte connecting the at least one first electrode and the at least one second electrode.

One example embodiment of the present invention is based on the realization that the abovementioned anode reactions are greatly favored, in usual lambda probes, by the selection of materials of such sensor elements that was usual up to now. Thus, platinum or a platinum compound (e.g., a platinum cermet) is preferably used as the anode material. This anode material is particularly temperature stable, and is consequently well compatible with the usual high temperatures that occur in ceramics processing, in contrast to metals such as silver, lead or gold. On the other hand, platinum itself is catalytically very active, so that it is used in typical catalysts. However, this high catalytic activity favors the abovementioned anode reactions. The catalytic activity of the platinum, that is present anyway, is particularly favored by the proceeding electrolytic processes, which is denoted as electrocatalytic activity. Highly reactive oxygen ions issue from the solid electrolyte in the area of the platinum anode, which react directly with the combustion gases at the platinum anodes, while transferring the free electrons to the platinum electrode.

Accordingly, according to an example embodiment of the present invention, the at least one second electrode, which is particularly able to be connected as pump anode, has a lower catalytic (especially electrocatalytic) activity than is the case with platinum electrodes. The at least one second electrode is thus selected to have a lower electrocatalytic activity compared to the at least one oxidizable component than the at least one first pump electrode. This may be implemented especially in that the at least one second electrode has a platinum electrode having an admixture of a catalytically inactive metal, particularly gold and/or silver and/or copper and/or lead, especially in the range between 0.05 wt. % to 5 wt. %, especially preferred between 0.1 wt. % and 1.0 wt. %. Furthermore, the at least one second electrode may also have a platinum electrode that is at least partially covered by a catalytically inactive metal, particularly gold and/or silver and/or copper and/or lead, the at least partial covering being preferably incomplete. Alternatively or in addition, the at least one second electrode may also have an oxide, particularly a metal oxide, and especially a metal oxide based on a perovskite and/or a chromite and/or a gallate. The use of ceramic-metal composite materials is also possible. Finally, the at least one second electrode may also have a mixture of at least one oxide ceramic and gold and/or silver and/or copper and/or lead.

The materials described may also be denoted as “combustion gas-sensitive electrode materials.” Because of their reduced electrocatalytic properties (at least in the here generally relevant non-equilibrium exhaust gas at λ≧1), these materials inhibit the anodic oxidation reactions and, at least at low combustion gas concentrations, they are able to ensure the uniqueness of the Iₚ(λ) characteristics curve in the range air>λ>1.0. In contrast to platinum electrodes, the electrode function of these combustion gas-sensitive electrodes (mixed potential electrodes, electrodes having a non-Nernst behavior) are no longer determined thermodynamically, but kinetically. The electrode potentials of the provided second electrode deviate from the Nernst equation, and mixed potentials are created. The electrocatalytically active, combustion gas-sensitive electrodes thereby avoid a current signal resulting from the combustion gas oxidation at the at least one second electrode and the H₂O decomposition at the at least one first electrode. In particular at low combustion gas concentrations, at least theoretically, using such a selection of material of the at least one second electrode, one is able to take a measurement all the way down to λ=1.0. Accordingly, the sensor element provided results in an unambiguous pumping current characteristics curve in the range of air>λ≧1.0. With that, cost-effective sensor elements, even ones that are constructed as one-cell units or as air reference, may be implemented for use particularly in motor vehicles, especially in Diesel motor vehicles.

For reasons of compatibility with the production process (especially the sintering conditions in ceramics production) and the operating conditions (temperature, atmosphere, etc.), besides the abovementioned oxide electrodes, particularly the alloys named and/or the modifications of platinum electrodes by additional metals, appear suitable for lowering the electrode activity of the at least one second electrode. These additional metals, such as gold, silver, copper or lead, act as “catalyst poisons” and lower the activity of the platinum electrodes. Actually, one is able to impregnate platinum electrodes with the “catalyst poisons” mentioned. Gold, for example, predominantly attaches to the platinum surface, so that even small quantities of this metal (e.g. 0.1 to 1.0%) massively influence the electrode activity, and lead to a measurable combustion gas sensitivity of the electrode.

It has been shown that the basic idea described, of the suppression of the reactions, at the at least one second electrode, by the choice of the electrode materials mentioned can be additionally improved if the at least one second electrode is, in addition, screened from the gas chamber. Thus, for instance, pump anodes in conventional sensor elements (such as described in European Patent No. EP 1 324 027 A2) are typically screened from the gas chamber only by a porous protective layer, through which oxygen, created at the anodes, is simply able to escape. Through this porous protective layer, however, combustion gas, especially the abovementioned combustion gas components, are simultaneously able to reach the pump anode.

Accordingly, it is provided as an advantageous refinement of the abovementioned present invention, that one should screen the at least one second electrode additionally from the at least one gas chamber in such a way that, to be sure, on the one hand, the oxygen (or any other appropriate identifiable gas component) forming at the at least one second electrode is able to flow away to the at least one gas chamber and/or to the at least one additional chamber (reference chamber), at the same time, however, diffusion of combustion gases in the opposite direction, that is, towards the at least one second electrode, being suppressed. For this purpose, the at least one second electrode is advantageously able to be connected to the at least one gas chamber and/or the at least one reference chamber via at least one diffusion resistance element, and the at least one second electrode may be connected to the at least one gas chamber via at least one flow resistance element. In this context, the at least one flow resistance element and the at least one diffusion resistance element are designed so that at least one flow resistance element has a greater flow resistance than the at least one diffusion resistance element, and the at least one diffusion resistance element has a greater diffusion resistance than the at least one flow resistance element. In this context, the flow resistance, in any units, is defined as the resistance with which an element counters a compensating flow driven on both sides of this element by a pressure difference, whereas diffusion resistance is defined as the resistance with which the element counters a particle exchange as a result as a concentration difference or a partial pressure difference between the two sides of this element.

In this context, it is particularly preferred if the sensor element is designed so that the limiting current of the at least one second electrode (inclusive of the at least one diffusion resistance element) is less than the limiting current of the at least one first electrode (inclusive of the at least one flow resistance element). The limiting current of the at least one second electrode is advantageously less than ⅕ of the limiting current of the at least one first electrode, and, particularly preferred, less than 1/10 of the limiting current of the at least one first electrode. The limiting current of an electrode is defined, in this context as the saturation pumping current, i.e., the maximum pumping current that is achievable between the electrodes in response to the increase in the pumping voltage. This limiting current may be defined, for oxygen and oxygen ion transport through the solid electrolyte, for example, as that current which is achieved if all the oxygen molecules, which reach the pump cathode, are transported completely through the solid electrolyte to the pump anode. The sensor element is normally operated using this limiting current, that is, having a sufficient pumping voltage (see above), so that this complete “transporting away” of arriving gas molecules is achieved (limiting current probe). The limiting current of the pump anode is determined experimentally, for example, by changing polarity, so that now the previous pump anode is operated as the pump cathode.

The above mentioned advantageous connection between the limiting currents brings about the screening effect of the at least one second electrode from reducing gases such as hydrogen. It is especially favorable if this screening comes about because the at least one diffusion resistance element has a diffusion channel that connects the at least one second electrode to the at least one gas chamber and/or to the at least one reference chamber. This diffusion channel (it being also possible to provide a plurality of diffusion channels) should preferably have great length, i.e., a length that is great compared to the mean free path of the gas molecules at the appropriate operating temperature of the sensor element. In this way, the difference between gas phase diffusion and flow resistance is utilized maximally so as to bring about the screening of the at least one second electrode. For, if the gas molecules in the at least one diffusion channel had no other collision partners besides the walls of the diffusion channel, the transportation would occur only via Knudsen diffusion, having the same response to flow and diffusion. By contrast, because of the design as a long diffusion channel, having a narrow cross section, an only slight diffusion transport of rich gas comes about to the at least one second electrode, and consequently only a small rich gas current. The at least one diffusion channel is advantageously furnished with a height in the range between 2 L to 25 L and a width in a range of 2 L to 25 L, as well as a length in the range between 0.5 mm and 20 mm. The L, in this context, is the mean free path of the molecules in the gas mixture, at an operating pressure of the sensor element that is usually within range of normal pressure. This dimensioning of the at least one diffusion channel has proven to be especially favorable for preventing the diffusion of rich gas to the at least one second electrode.

All in all, the design of the sensor element as in the present invention, according to one of the above specific example embodiments, has extremely small rich pumping currents, and consequently, by an extremely slight deviation of the pumping current characteristics curve from the theoretical characteristics curve. As a result, an interpretation is also possible of the pumping current in the lean range, i.e., down to very small values for λ. Because of the at least one diffusion resistance element in the area of the at least one second electrode, which screens the at least one second electrode from diffusion, the increase in the “rich branch” is prevented in targeted fashion. At the same time, because of the design of the at least one diffusion resistance element as an element having a low flow resistance, the danger of an overpressure in the area of the at least one second electrode by a lacking transportation away of the gas is prevented, since gas molecules that form at the at least one second electrode are able to flow away directly. An additional advantage of the design according to the present invention is that a reference channel is not necessarily required, which would have to be screened from the gas chamber in a costly manner. In this way, for example, the requirements on the probe housing that surrounds the at least one sensor element drop off.

In an additional advantageous embodiment, at least one cavity that is in connection with the at least one second electrode is provided. This cavity is advantageously connected via the at least one diffusion channel to the at least one gas chamber and/or the at least one reference chamber. This at least one cavity may include a widening of the at least one diffusion channel, for example. Alternatively or in addition, the at least one cavity may also include a reaction chamber bordering directly on the at least one second electrode, which encloses the entire at least one second electrode on one side. This at least one cavity is used for the purpose so that, for example, hydrogen or other reducing gases are able to react to completion, for instance, by forming water, before these reach the at least one second electrode and influence the electrode potential there. In the at least one cavity, a catalyst may also additionally be provided, for example, in order to accelerate this reaction of reducing gases to completion.

Furthermore, the at least one diffusion resistance element may also include at least one porous element, for instance, a porous layer. A coarsely porous ceramic may be involved in this context, for example, which still forms a slight flow resistance for gases flowing away from the at least one second electrode. This at least one porous element offers the advantage of protecting the at least one second electrode from additional contamination, and represents an additional obstacle for penetrating combustion gases.

The at least one flow resistance element before the at least one second electrode may, for instance, be designed conventionally. Thus, this at least one flow resistance element advantageously also has at least one porous element. That being the case, this at least one diffusion resistance element corresponds to the “diffusion barrier” usually installed in broadband probes before the inner potential electrode, as described, for example, in Robert Bosch GmbH: “Sensors in the Motor Vehicle”, 2001, pp. 116 ff. This porous element of the at least one flow resistance element is advantageously designed as a porous, extremely dense layer, a static pressure dependence k being advantageously used which amounts to at least 1 bar, but is preferably higher. A static pressure dependence k, in this context, denotes the relationship between Knudsen diffusion and gas phase diffusion, which, at k=1 bar, are of just the same size. At higher k values, the Knudsen diffusion consequently dominates. Relevant pore sizes for the Knudsen diffusion are known to one skilled in the art.

One further advantageous possibility of, on the one hand, promoting a diffusion of gas through the at least one flow resistance element to the at least one first electrode and, on the other hand, suppressing a diffusion of combustion gases from the at least one gas chamber through the at least one diffusion resistance element to the at least one second electrode, is to provide an asymmetric temperature regulation of the electrodes. For this purpose, the sensor element can have, for instance, at least one temperature-regulating element which is designed to operate the at least one second electrode at a lower operating temperature than the at least one first electrode. In this way, diffusion processes from the at least one gas chamber to the at least one second electrode are suppressed, so that the number of reactions running per time unit is reduced at the at least one second electrode. This asymmetric temperature regulation is able to be implemented by separating the at least one tempering element from the at least one first electrode and the at least one second electrode by a different distance. In this context, the distance between the at least one temperature-regulating element and the at least one first electrode is selected to be at least 20% greater than the distance between the at least one heating element and the at least one second electrode. A minimal distance between the electrode and the heating element may be defined as the “distance”, in this context, or, alternatively, a distance between an edge of the at least one heating element and an edge of the electrode.

The sensor element, described in one of the designs provided, is advantageously operated in a method for measuring a gas mixture composition in such a way that, between the at least one pump anode and the at least one pump cathode, a pumping voltage is applied, particularly between 100 mV and 1.0 V, preferably between 300 mV and 800 mV, and especially preferred between 600 mV and 700 mV, preferably a constant pumping voltage, a pumping current flowing between the at least two electrodes being measured. Using a suitable wiring configuration, the at least one first electrode is preferably operated, at least at times, as a pump cathode, in this context, whereas the at least one second electrode is operated as a pump anode, at least at times.

### BRIEF DESCRIPTION OF THE DRAWINGS

Exemplary embodiments of the present invention are shown in the figures and are explained in greater detail below.

FIG. 1 shows a first exemplary embodiment of a radially symmetrical sensor element developed as a one cell unit.

FIG. 2 shows a schematic representation of pumping current characteristics curves through a pump cell.

FIG. 3 shows a second exemplary embodiment of a sensor element having an internal pump anode.

FIG. 4 shows a third exemplary embodiment of a sensor element having side-by side pump electrodes.

### DETAILED DESCRIPTION OF EXAMPLE EMBODIMENTS

FIG. 1 shows a first exemplary embodiment of a sensor element 110 according to the present invention. A sensor element 110 is involved, which is able to be used in a lambda probe or as a lambda probe, in order to determine the gas composition (air ratio) in a gas chamber 112. Sensor element 110 is designed in a radially symmetrical layer construction, having a solid electrolyte 114 on which, on opposite sides, an inner pump cathode 116 is situated, and on the outside a pump anode 118 is situated on the side facing the gas chamber 112. During operation, voltages are applied between the two pump electrodes 116, 118 in the region described above, and a current (pumping current Iₚ) is measured between the two electrodes 116, 118. In general, let us assume that the at least one first electrode is connected as pump cathode 116 and the at least one second electrode of the sensor element 110 as pump anode 118. A different wiring configuration is also conceivable, however, or even a wiring configuration in which, depending upon the state of operation, the cathode and the anode functions are exchanged, for instance, within the scope of a regulation, or in which the at least two electrodes are used, wholly or partially or even just from time to time, as components of a measuring cell (Nernst cell).

In front of pump cathode 116, which may preferably be developed as a platinum electrode, a cathode cavity 120 is developed, in the form of a rectangular hollow space. A gas mixture from gas chamber 112 enters sensor element 110 through a gas access hole 122 in sensor element 110, and is able to reach cathode cavity 120 from there. Between gas access hole 122 and cathode cavity 120, a flow resistance element 124 in the form of a porous, impervious material is situated, which limits the limiting current of pump cathode 116.

In this exemplary embodiment, pump anode 118 is designed as a combustion gas-sensitive pump anode, for instance, as one of the abovementioned platinum electrodes having an admixture of gold in a range between 0.1 and 1.0%. In this way, the abovementioned electrode reactions at pump anode 118 may already be greatly suppressed, since the electrocatalytic activity of such electrode compositions drops off greatly, compared to platinum.

At the same time, however, an additional possibility is shown in FIG. 1, for further suppressing the rich gas reactions described at pump anode 118. While in the right-hand part of the illustration (marked A in FIG. 1) pump anode 118 is screened off from gas chamber 112 only by a simple protective layer 126 (usually a porous gas-permeable material), in the left-hand part of this schematic representation (marked B in FIG. 1), pump anode 118 has a diffusion resistance element 128. Pump anode 118 is surrounded by a gas-impermeable cover layer 130, in this context, in which a rectangular cavity 132 is developed above pump anode 118. This cavity 132 is connected to gas access hole 122 via a long diffusion channel 134, which opens out on gas access hole 122. For the dimensioning of diffusion channel 134 we refer to the above description. At the opening location of diffusion channel 134 into the gas access hole, a widening 136 is provided so as to prevent diffusion channel 134 from being clogged up by dirt that penetrates from gas chamber 112. Because of diffusion channel 134 it is possible, on the one hand, that oxygen forming at pump anode 118 is able to flow away into gas chamber 112. On the other hand, penetration into cavity 132 above pump anode 118 is made more difficult for combustion chamber gases by the long diffusion path. In addition, as was described above, cavity 132 creates a spatial possibility for the reaction to completion of penetrating combustion gases, such as hydrogen.

Sensor element 110 according to the exemplary embodiment in FIG. 1 may be modified in many ways. For instance, departing from the radial design shown here, a linear design may also be selected. Furthermore, one may see in FIG. 1 that, below pump anode 118, pump cathode 116 and solid electrolyte 114, which together form a pump cell 138, a heating element 140 is provided, which is made up of insulating layers 142 and heating resistors 144 situated between them. Using this heating element 140, which acts as a temperature-regulating element 146, one may, for example, set an operating temperature of sensor element 110 at 500 to 600° C., the temperature being adjusted, for instance, to optimize the electrolytic properties of solid electrolyte 114.

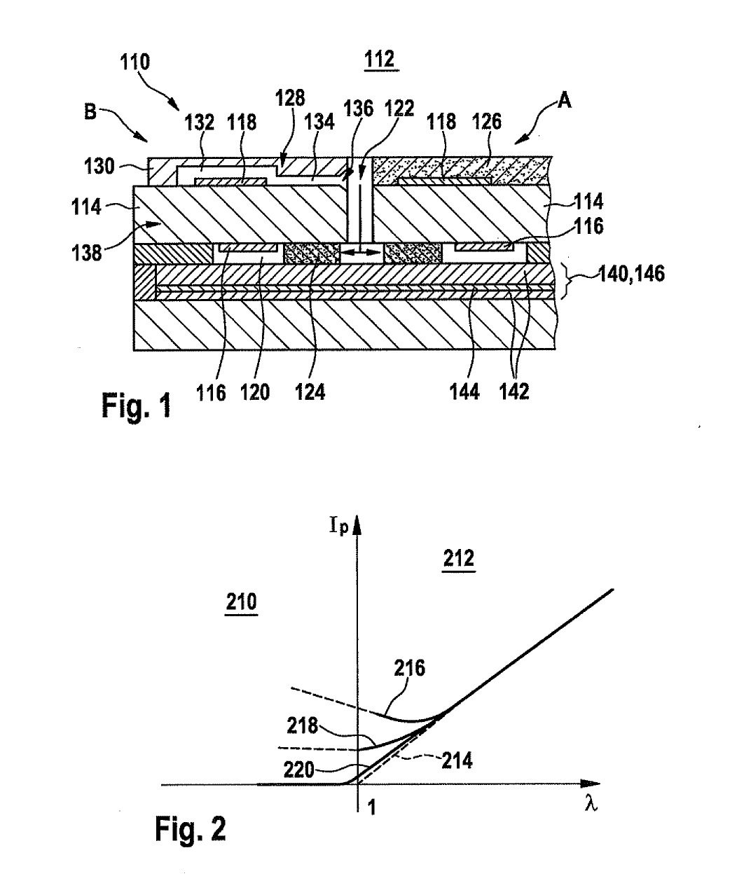

FIG. 2 schematically shows the effect of the measures described above on the characteristics curve (pumping current Iₚ as a function of air ratio λ) of sensor element 110 shown in FIG. 1. Pumping current Iₚ is plotted here against the air ratio. In theory, pumping current Iₚ should be at zero in rich range 210, that is, on the λaxis. At λ=1 and larger λ values (lean region 212), pumping current Iₚ should then rise approximately linearly with air ratio λ, which is shown in FIG. 2 in dashed fashion by theoretical characteristics line 214. In actual fact, however, in sensor elements 110 having platinum anodes one should look at characteristics curve 216, which only approximates theoretical curve 214 at high λ values. In the slightly lean range, approximately at λ=1, characteristics curve 216 then deviates, however, from theoretical curve 214 and even rises again, in the direction towards smaller λ values. Schematically, characteristics curve 218 shows the course of a characteristics curve having anodes “poisoned” according to an example embodiment of the present invention, such as platinum pump electrodes 118 that have the abovementioned admixture of gold. It may clearly be seen that the deviation from theoretical curve 214 is less in the slightly lean range. In particular, no rise takes place again in the characteristics curve, going towards smaller λ values, so that uniqueness of the course of the characteristics curve (an inference of air ratio 2 from pumping current Iₚ) is ensured. Finally, characteristics curve 220 shows pump anode 118 shown in B in FIG. 1, at which, in addition to the above-mentioned “poisoning”, diffusion resistance element 128 is implemented. It may clearly be seen that this characteristics curve 220 well approximates theoretical curve 214. Consequently, a measurement down to small λ values is possible, that is, λ values barely above 1.

FIG. 3 shows an additional exemplary embodiment of a sensor element 110, which again has a pump cell 138 having a pump cathode 116 and a pump anode 118, and a solid electrolyte 114 lying between them. In contrast to the exemplary embodiment shown in FIG. 1, however, in the exemplary embodiment shown in FIG. 3, pump cathode 116 is situated so as to lie on top of solid electrolyte 114, and pump anode 118 lies towards the inside. In order to screen it from gas chamber 112, a gas-impermeable cover layer 130 is situated over pump cathode 116, so that once again an approximately rectangular-shaped cathode cavity 120 is developed over pump cathode 116. This cathode cavity 120 is screened from gas chamber 112 by flow resistance element 124, which is designed, for instance, as in the exemplary embodiment shown in FIG. 1.

A gas access hole 122 is provided again, which in this case, however, is not used for the purpose of supplying gas to pump anode 118 (as in the exemplary embodiment shown in FIG. 1, for gas supply to pump cathode 116), but is used for the escape of oxygen from a cavity 132 on the inside of sensor element 110, in which pump anode 118 is situated. Accordingly, gas access hole 122 which, in this case, is simply no longer an “access hole”, can be designed to have a smaller cross section, for example, than gas access hole 122 in the exemplary embodiment shown in FIG. 1. That being the case, the diffusion resistance is additionally increased. Thus, in the exemplary embodiment shown in FIG. 3, gas access hole 122 forms a part of diffusion resistance element 128, which prevents or lowers the diffusion of combustion gases from gas chamber 112 into cavity 132 via pump anode 118, and, at the same time, makes possible the flowing away of oxygen from cavity 132. In addition, in FIG. 3, cavity 132 is screened from gas chamber 112 by a porous element 310, a coarse-pored, porous element being advantageously involved. Pump anode 118 may be made up of the same material, as was described above.

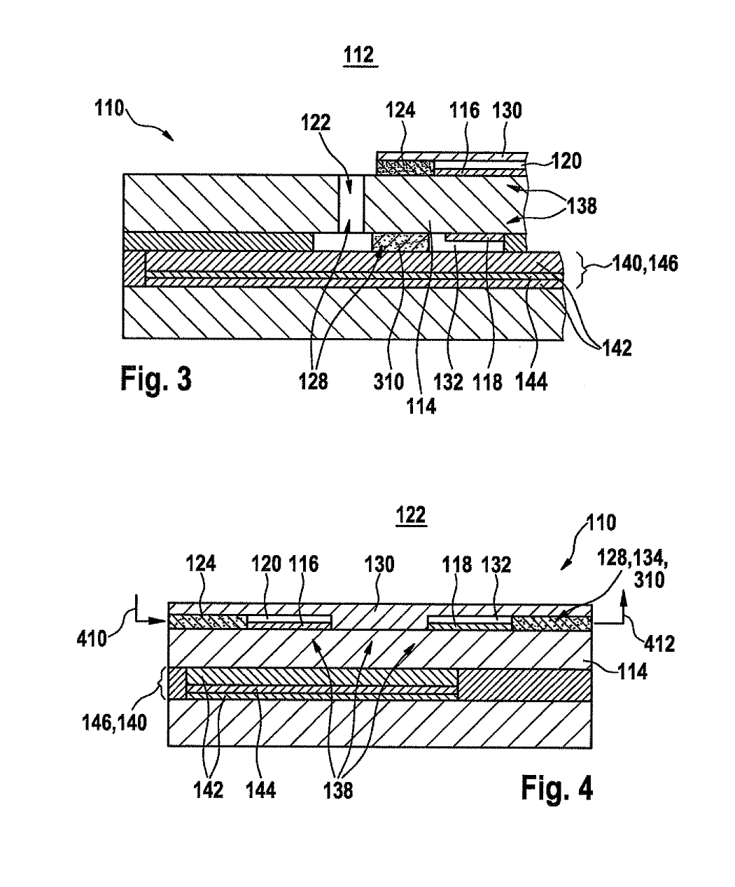

Finally, in FIG. 4 a third exemplary embodiment of a sensor element 110 is shown, which implements a layer construction having pump cathode 116 and pump anode 118 situated on the same side of solid electrolyte 114. Once again, pump anode 118, pump cathode 116 and solid electrolyte 114 form a pump cell 138, the pumping current, however, now flowing essentially in the horizontal direction, parallel to the layer planes, between electrodes 116, 118. Above pump cathode 116, which is again developed as a platinum cathode, for example, a cathode cavity 120 is again developed, which is screened off from gas chamber 112 by a gastight cover layer 130. Cathode cavity 120 is separated from gas chamber 112 via a flow resistance element in the form of an impervious, small-pored ceramic layer, analogously to the preceding exemplary embodiments.

In this exemplary embodiment, pump cathode 118 is again a “poisoned” platinum electrode, such as a platinum electrode having a gold layer printed over it for adjusting the combustion gas sensitivity. Over pump anode 118, a cavity 132 is again developed, which is also separated from gas chamber 112 by a gastight cover layer 130. Cavity 132 is separated from gas chamber 112 by the one diffusion channel 134, a porous element 310 being again inserted into diffusion channel 134, analogously to the exemplary embodiment in FIG. 3. Diffusion channel 134 and porous element 310 act together as diffusion resistance element 128, with regard to the dimensioning of diffusion channel 134, the above description being referred to.

Furthermore, as also in the preceding exemplary embodiments, in the exemplary embodiment according to FIG. 4, too, a heating element 140 is again provided. By contrast to the preceding exemplary embodiments, in this planar arrangement having electrodes 116, 118 lying side-by-side, in the example according to FIG. 4, an asymmetrical heating is implemented in which pump anode 118 and diffusion resistance element 128 in spatial section are heated by a temperature which is about 20% below the average temperature of pump cathode 116 and flow resistance element 124. For this purpose, heating element 140 is situated so that it does not fully cover laterally pump anode 118 and diffusion resistance element 128, since heating element 140 does not extend to the same degree to the right-hand edge of sensor element 110 as to the left-hand edge. Because of the increased operating temperature on the part of pump cathode 116, a gas inlet, designated in FIG. 4 symbolically by 410, from gas chamber 112 into cathode cavity 120 through porous flow resistance element 124 (diffusion process) is favored. At the same time, because of the low operating temperature on the part of pump anode 118, an outflow of oxygen (gas outflow 412) from cavity 132 into gas chamber 112 is made possible, diffusion of combustion gases from gas chamber 112 into cavity 132 through diffusion channel 134 and porous element 310, however, being suppressed based on the lower temperature.

1-15. (canceled)

16. A sensor element for determining at least one physical property of a gas mixture in at least one gas chamber, the gas mixture composition including at least one component to be identified and at least one oxidizable component, the sensor element comprising:
at least one first electrode;
at least one second electrode; and
at least one solid electrolyte connecting the at least one first electrode and the at least one second electrode;
wherein the at least one second electrode has a lower catalytic activity with respect to the at least one oxidizable component than the at least one first electrode.

17. The sensor element as recited in claim 16, wherein the at least one component to be identified is oxygen, the at least one oxidizable component is a combustion gas, and the at least one second electrode has a lower electro catalytic activity with respect to the at least one oxidizable component than the at least one first electrode.

18. The sensor element as recited in claim 16, wherein the at least one second electrode has at least one of the following properties:
the at least one second electrode has a platinum electrode having an admixture of a catalytically inactive metal in the range between 0.05 wt. % to 5 wt. %,
the at least one second electrode has a platinum electrode that is at least partially covered by a catalytically inactive metal, the at least partial covering being preferably incomplete;
the at least one second electrode has a metal oxide based on at least one of a perovskite, a chromite, and a gallate;
the at least one second electrode has a ceramic-metal composite material;
the at least one second electrode has a mixture of at least one oxide ceramic and at least one of the following metals: gold, silver, copper, lead.

19. The sensor element as recited in claim 16, wherein the at least one second electrode is connected to at least one diffusion resistance element via at least one of: i) the at least one gas chamber, and ii) at least one reference chamber, the at least one first electrode being connected to the at least one gas chamber via at least one flow resistance element; the at least one flow resistance element and the at least one diffusion resistance element being designed so that the at least one flow resistance element has a greater flow resistance than the at least one diffusion resistance element, and the at least one diffusion resistance element has a greater diffusion resistance than the at least one flow resistance element.

20. The sensor element as recited in claim 19, wherein the at least one flow resistance element and the at least one diffusion resistance element are designed so that a limiting current of the at least one second electrode is less than a limiting current of the at least one first electrode.

21. The sensor element as recited in claim 20, wherein the limiting current of the at least one second electrode is less than ⅕ of the limiting current of the at least one first electrode.

22. The sensor element as recited in claim 21, wherein the limiting current of the at least one second electrode is less than 1/10 of the limiting current of the at least one first electrode.

23. The sensor element as recited in claim 19, wherein the at least one diffusion resistance element has a diffusion channel via which the at least one second electrode is connected to at least one of: i) the at least one gas chamber, and ii) the at least one reference chamber.

24. The sensor element as recited in claim 23, wherein the at least one diffusion channel has a channel that has a height in a range of 2 L to 25 L, a width in a range of 2 L to 25 L and a length in the range of 0.5 mm to 20 mm, L being a mean free path of molecules of the gas mixture at an operating pressure and an operating temperature of the sensor element.

25. The sensor element as recited in claim 23, wherein at least one additional cavity is connected to the at least one second electrode, the at least one additional cavity being connected to at least one of: i) the at least one gas chamber, and ii) the at least one reference chamber via the at least one diffusion channel.

26. The sensor element as recited in claim 19, wherein the at least one diffusion resistance element has at least one porous element.

27. The sensor element as recited in claim 19, wherein the at least one diffusion resistance element has a reference channel, the at least one reference channel connecting the at least one first electrode to at least one reference chamber that is separated from the at least one gas chamber.

28. The sensor element as recited in claim 16, further comprising:
at least one temperature-regulating element, the at least one temperature-regulating element being designed so as to operate the at least one second electrode at a lower operating temperature than the at least one first electrode.

29. The sensor element as recited in claim 28, wherein the at least one temperature-regulating element is at a different distance from the at least one first electrode and the at least one second electrode, the distance between the at least one temperature-regulating element and the at least one first electrode being at least 20% greater than the distance between the at least one temperature-regulating element and the at least one second electrode.

30. A method for determining at least one physical property of a gas mixture, comprising:
providing a sensor element, the sensor element including at least one first electrode, at least one second electrode, and at least one solid electrolyte connecting the at least one first electrode and the at least one second electrode, wherein the at least one second electrode has a lower catalytic activity with respect to the at least one oxidizable component than the at least one first electrode;
applying a pumping voltage between the at least one second electrode and the at least one first electrode; and
measuring at least one pumping current flowing between the at least one first electrode and the at least one second electrode.

31. The method as recited in claim 30, wherein the at least one first electrode is operated at least at times as a pump cathode; and the at least one second electrode is operated at least at times as a pump anode.

32. The method as recited in claim 31, wherein a pumping voltage is between 100 mV and 1.0 V.

33. The method as recited in claim 32, wherein a pumping voltage is between between 300 mV and 800 mV.

34. The method as recited in claim 33, wherein a pumping voltage is between 600 mV and 700 mV.
